(19) United States
(12) Patent Application Publication
(10) Pub. No.: US 2006/0278484 A1
(43) Pub. Date: Dec. 14, 2006

(54) Radially expanding braking device

(76) Inventor: Slavo Antolovic, Tinjan (HR)

Correspondence Address: Intellectual Property Group;Bose McKinney & Evans LLP, 2700 First Indiana Plaza, 135 North Pennsylvania Street, Indianapolis, IN, 46204, US

(21) Appl. No.: 11/149,743

(22) Filed: Jun. 10, 2005

(51) Int. Cl. F16D 51/00

(52) U.S. Cl. 188/323; 188/78

(57) ABSTRACT

A radial expanding braking device for use with a motor vehicle. The braking device including a drum, a plurality of carrying elements and a lifting mechanism configured to selectively move the plurality of carrying elements into contact with the drum.

### FIELD OF THE INVENTION

The invention relates generally to friction brake systems. More specifically it relates to friction brake systems to slow and to stop a vehicle. In addition to brake systems, the invention can also be applied as a non-permanent clutch for distribution of torque.

### BACKGROUND AND SUMMARY

Brake systems are typically used in motor vehicles where there is a need for an application of a mechanical force to slow and eventually stop the vehicle. Brake systems are usually divided into disc brake and drum brake systems.

Typically, disc brakes include a disc rigidly connected to a vehicle axle and brake elements positioned on brake calipers. The disc has the same direction of rotation as the axle. The brake elements are positioned near the edge of the disc on both sides of the disc. The disc is clamped by the brake elements actuated to stop the vehicle. The clamping by of the brake elements on the disc results in friction which slows and eventually stops the vehicle.

Typically, drum brakes consist of a drum housing that is rigidly connected to the vehicle axle. Braking elements, which typically include a pad, are set within the drum and act radially, as opposed to disc brakes' braking elements that act axially. Braking in a drum brake system is done by radial expansion of the braking elements that produce friction between the drum and the braking elements. The mechanism moving the braking elements inside the drum is more complicated than the mechanism used in disc brakes. One end of braking element is rigidly connected to a pivot point allowing the element only to move radially around the pivot. The other end is pushed outwards against the drum to create the friction. The resulting movement of the pad's surface is unequal so the resulting pressure of the pad on the drum is not equal along the working surface of the pad. Consequently, the efficiency of the braking pad is not optimal nor is the wear of the pad equal along its working surface.

In accordance with one aspect of the present invention, there is provided a braking device for use with a motor vehicle. The braking device includes a drum, a lifting mechanism, a plurality of carrying members, a plurality of pins, and at least one cylinder. The drum includes an inner surface. The lifting mechanism includes a plurality of teeth. The plurality of carrying members is operably coupled to the plurality of teeth. The carrying members are configured to extend outwardly from a center axis of the lifting mechanism. Each carrying member includes a pad for selective engagement with at least a portion of the drum. The plurality of pins operably couples the plurality of carrying members to the lifting mechanism. The at least one cylinder is selectively engageable with the lifting mechanism. Engagement of the at least one cylinder extends the plurality of carrying members outward from the center axis.

In another aspect of the invention there is provided a braking device for use with a motor vehicle. The braking device includes a drum, a lifting mechanism, at least three carrying members, and at least one cylinder. The drum includes an inner surface. The lifting mechanism includes a first tooth, a second tooth, and a third tooth. The at least three carrying members each are operably coupled to one of the first tooth, the second tooth, and the third tooth. Each carrying member is configured to extend outwardly from a center axis of the lifting mechanism thereby selectively engaging at least a portion of the drum. The at least one cylinder is selectively engageable with the lifting mechanism. Engagement of the at least one cylinder extends the three carrying members outward from the center axis.

### BRIEF DESCRIPTION OF THE DRAWINGS

FIG. 1A is a front perspective view of a braking device attached to an axle, the braking device including a leading plate, a lifting mechanism, a carrying element and a drum;

FIG. 1B is a rear perspective view of the braking device further including a leading plate and a suspension attachment plate;

FIG. 1C is a front perspective view of the braking device of FIG. 1A with the lifting mechanism removed;

FIG. 2A is a front perspective view of the braking device of FIG. 1A with the drum removed;

FIG. 2B is a rear perspective view of the braking device of FIG. 1B with the leading plate and suspension attachment plate removed;

FIG. 2C is a front perspective view of the braking device of FIG. 1A with the drum and a carrying element removed;

FIG. 3 is a front perspective view of the braking device with the drum, lifting mechanism, and carrying elements removed;

FIG. 4 is a perspective view of the carrying element;

FIGS. 5A-D are perspective views showing movement of the carrying elements during operation of the braking device; and

FIG. 6 is a perspective view of an alternative embodiment of a braking device.

### DETAILED DESCRIPTION OF THE DRAWINGS

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

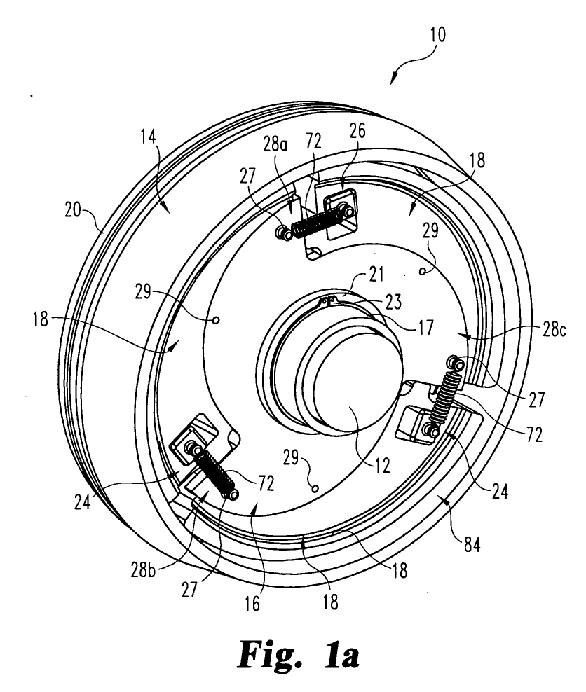

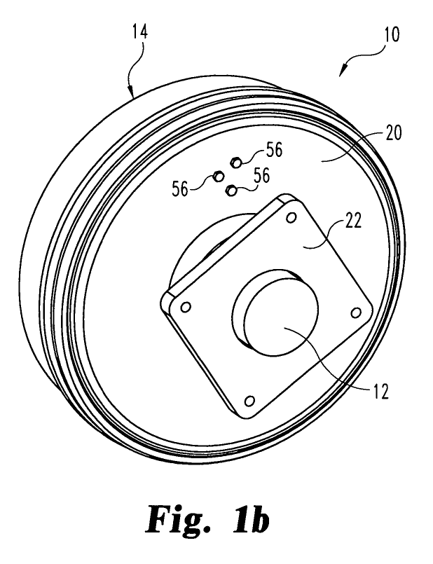

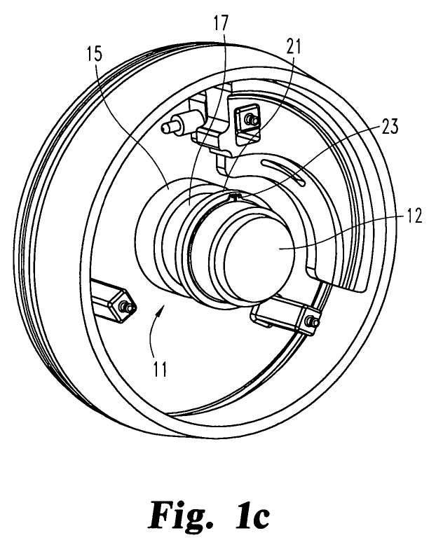

Referring now to FIGS. 1A-B, there is shown a braking device 10 attached to an axle 12 of a vehicle (not shown) for application of a mechanical force to slow and eventually stop the vehicle. The braking device 10 includes a drum 14, a lifting mechanism 16, a plurality of carrying elements 18, a leading plate 20, and a suspension attachment plate 22. Suspension attachment plate 22 is provided to attach the braking device 10 to a suspension (not shown) of the vehicle. Carrying elements 18 are actuated by lifting mechanism 16 through a pair of leading pin assemblies 24 and a leading pin actuation assembly 26. During vehicle braking, the carrying elements 18 engage the drum 14 to create a brake force that slows down and stops the vehicle.

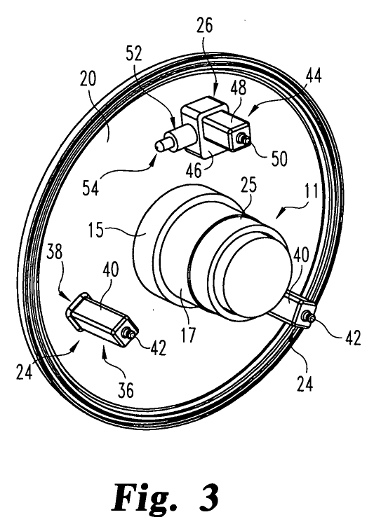

As shown in FIG. 3, a cylinder 11, attached to leading plate 20, supports the lifting mechanism 16 around the axle 12. The cylinder 11 includes an opening 13 to receive the axle 12 and the lifting mechanism 16 is placed over the cylinder 11. As shown in FIG 1C, the cylinder 11 includes a first portion 15 and a second portion 17. The First portion 15 has a larger outside diameter than the second portion 17. The lifting mechanism 16 is placed over the second portion 17 contacting the first portion 15. A distant ring 21 is placed over the second portion 17 to contact the lifting mechanism 18. A safety or snap ring 23 is provided for placement in a groove 25 on second portion 17 to hold the lifting mechanism 16 against the first portion 15 and the distant ring 21 against the lifting mechanism 16. The snap ring 23 and distant ring 21 prevent movement of the lifting mechanism 16 in an axial direction.

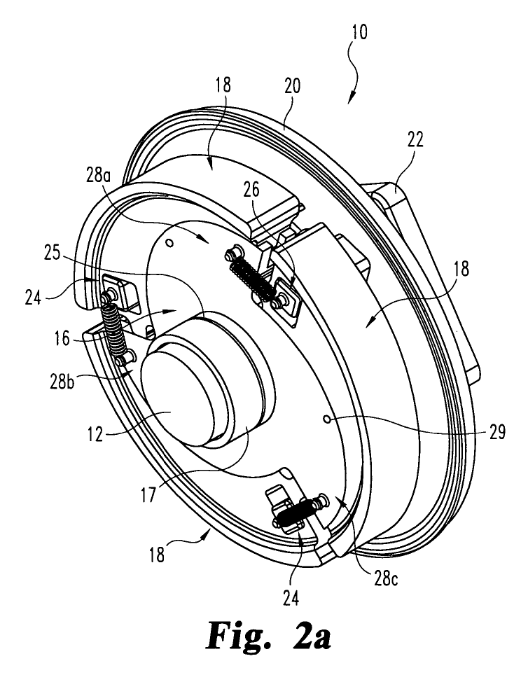

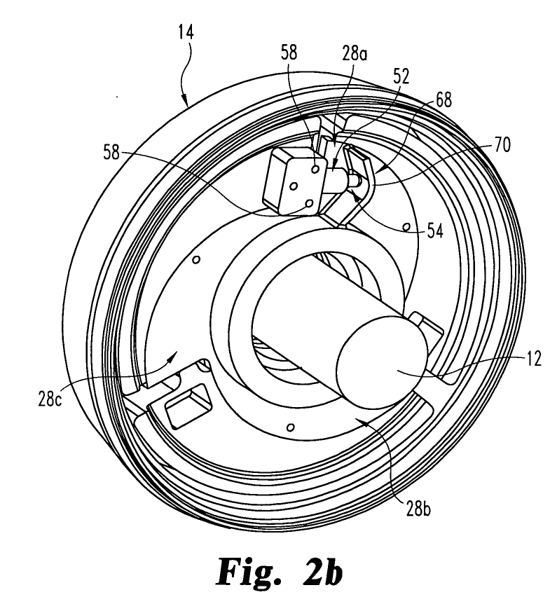

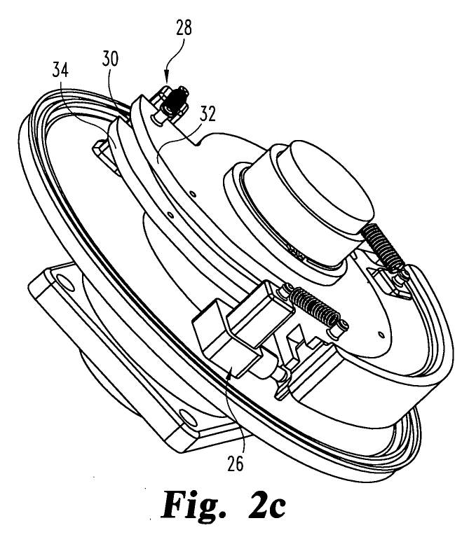

As shown in FIGS. 2A-C, the lifting mechanism 16 is a trident lifting mechanism including a plurality of teeth 28a-c. The teeth 28a-c are set at angles of approximately 120° from each other. Each tooth 28a-c has a cylindrical outer shape. Each tooth 28a-c includes a return post 27, a carrying post 29, and a leading groove 30, best shown in FIG. 2C. The groove 30 defines a first portion 32 and a second portion 34 for each of the teeth 28a-c and disposed there between. The grooves 30 are radial in relation to the axle 12. In alternative embodiments, any numbers of teeth are provided and set at angles to provide maximum contact of the carrying elements 18 to drum 14. For example, two teeth, four teeth, five teeth, or six teeth could be provided.

As shown in FIGS. 1A and 3, leading pin assemblies 24 each include a fixed leading pin 36 having a base 38, a body 40, and a spring post 42. The base 38 of each fixed leading pin 36 is welded to the leading plate 20. The leading pin actuation assembly 26 includes a removable leading pin 44 having a base 46, a body 48, and a spring post 50. Base 46 includes an actuator or hydraulic cylinder 52 that includes an engagement portion 54. As shown in FIGS. 1B and 2B, a plurality of connectors 56, such as bolts, attach through a plurality of openings 58 to removable leading pin 44 to attach the removable leading pin 44 to the leading plate 20. Connectors 56 allow removable leading pin 44 to be removed or replaced during service of the braking device.

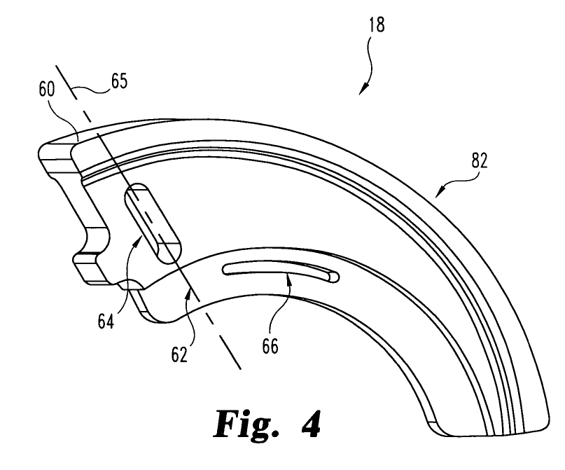

As shown in FIG. 4, each carrying element 18 includes a brake pad 60, a rib 62, and a leading pin groove 64. Leading pin groove 64 is sized to receive leading pin 24 to allow movement along a pin axis 65. The outer radius of the pad 60 matches the inner radius of the drum 14 so when the pad 60 engages the drum 14, the whole working surface of the pad/drum interface is efficiently used. The pad 60 wears uniformly such that pressure on the carrying element 18 is uniformly distributed so that the stresses have less effect on it. Each rib 62 includes a carrying groove 66 to receive the carrying pin 29 of the lifting mechanism 16.

Referring now to FIG. 2C, each carrying element 18 mounts to one of the plurality of teeth 28a-c. Rib 62 is received within groove 30. The carrying elements 18 slide along the lifting mechanism 16. Carrying elements 18 do not have a degree of freedom in the axial direction and only have limited movement in the radial direction. The carrying elements 18 movement in the radial direction is limited by the placement of the carrying pins 29 in the carrying grooves 66 and movement of the leading pins 34, 36 in the leading pin grooves 64. Grooves 30 act as a camming surface for rib 62 having a surface that is eccentric with respect to the center axis.

Referring now to FIG. 2B, the lifting mechanism 16 further includes an engagement plate 68 having a receiver portion 70. Receiver portion 70 is configured to engage the engagement portion 54 of the hydraulic cylinder 52. When the hydraulic cylinder 52 is actuated, the engagement portion 54 engages receiver portion 70. The cylinder 52 starts to create the pressure force to initiate movement of the lifting mechanism 16 the moment a brake pedal of the vehicle is pressed. Additional details of the operation of the braking device are discussed below.

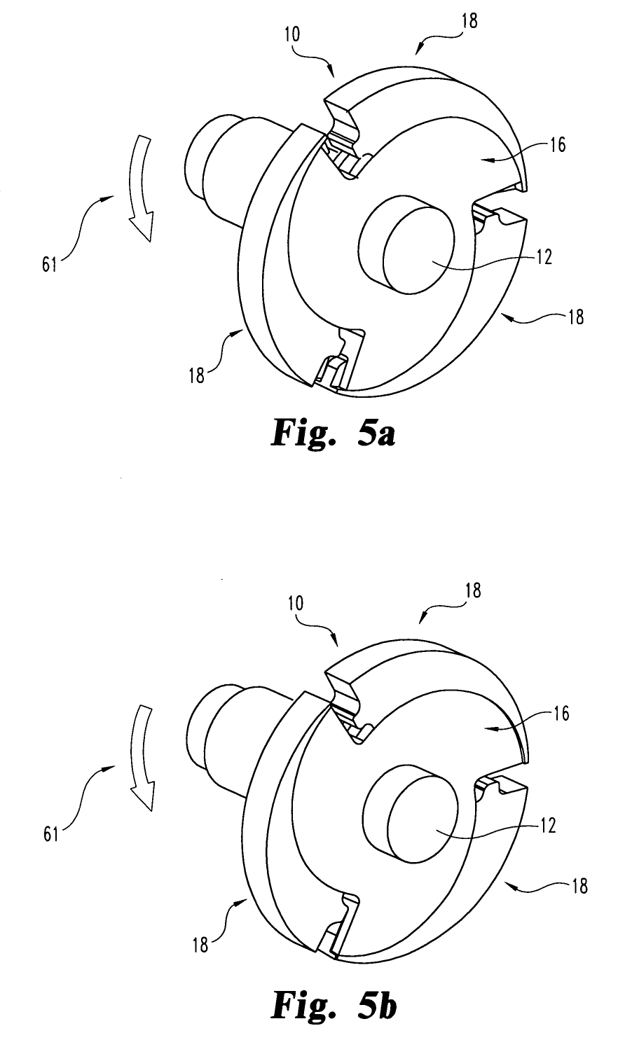

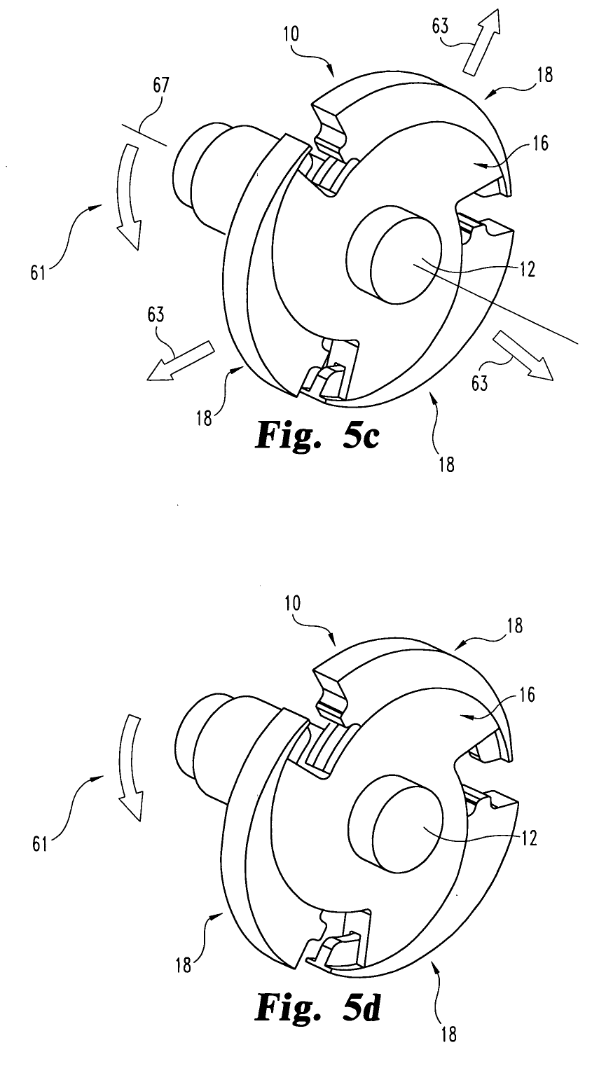

Referring generally to FIGS. 5A-D, operation of the brake device 10 starts when a user puts pressure on the brake pedal. Hydraulic cylinder 52 pushes the engagement portion 54 into the receiver portion 70 of the lifting mechanism 16. This rotates the lifting mechanism 16 around its central axis. The axle 12 runs through the central axis of both the lifting mechanism 16 and the leading plate 20. The lifting mechanism 16 and the leading plate 20 can move independently from each other.

During rotation of the lifting mechanism 16 in a first direction 61, grooves 30 of the lifting mechanism 16 slide under the ribs 62 of the three carrying elements 18. Each of carrying elements 18 expand outwards from the central axis as defined by the leading pins 36, 44 and leading pin grooves 64 in a second direction 63. Carrying elements 18 expand outwards in the second direction 63, away from the central axis and towards the drum 14.

When the pad 60 makes contact with the drum 14, friction causes braking. Considering that the outer part 82 of the pad 60 makes contact with an inner surface 84 of the drum 14, potentially more than 90% of the contact surface of the drum 14 is efficiently used for braking. Since pads 60 wear, it is intended for them to be replaceable. When they become unusable they may be taken off of the carrying elements 18 and replaced with new ones. The placement of the carrying pins 29 of the lifting mechanism 16 in the carrying grooves 66 on the carrying elements 18 insures the final position of the carrying elements 18 so that the carrying elements 18 may be prevented from colliding with the drum 14 no matter how worn the pads 60 are.

When the brake pedal is released, the brake system returns to the non-contacting or non-braking position for the next braking operation. This return is made by a plurality of springs 72. Springs 72 mount to return posts 27 of the lifting mechanism 16 and to spring posts 42, 50 of leading pins 36, 44 respectively. The springs 72 are mounted to move opposite the actuation direction of the hydraulic cylinder 52. During braking, the springs 72 extend thereby accumulating energy. After braking stops, the springs 72 return the lifting mechanism 16 and the carrying elements back to their starting or non-contacting positions. The device 10 is ready for braking.

The front or wheel facing side of braking device 10, shown in FIG. 1A, is closed off and protected by a drum housing (not shown) of the drum 14. On the backside, shown in FIG. 1B, the leading plate 20 protects the system, provided that the cylinder 50 and the springs 72 are hidden behind a small housing (not shown) of their own. This way the impurities may be prevented from penetrating inside the system.

The principle of braking can be applied in axial, frontal, direction. This requires the lifting mechanism 16 and the carrying elements 18 to be modified to expand axially. This allows the carrying elements 18 to contact the front portion of the drum 14 and the front portion becomes the working surface.

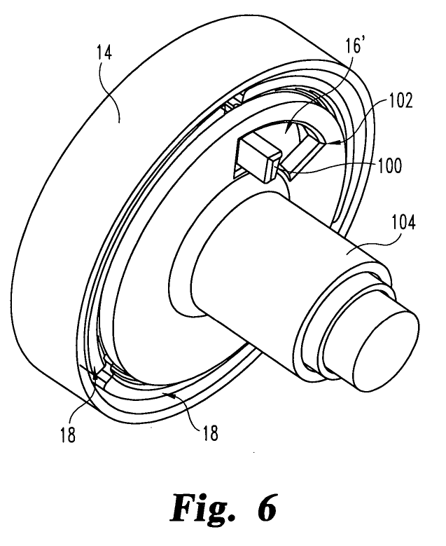

FIG. 6 depicts an alternative embodiment of the braking device. In this embodiment, the lifting mechanism 16′ includes a pressure pin 100 that a portion 102 of a hydraulic cylinder 104 engages to initiate braking. Pressure pin 100 and portion 102 would replace the engagement portion 54 and the receiver portion 70 of the lifting mechanism 16 of the previous embodiment.

While this invention has been described with specific embodiments thereof, alternatives, modifications and variations may be apparent to those skilled in the art. The device could be modified for use in a transmission. Accordingly, it is intended to embrace all such alternatives, modifications and variations that fall within the spirit and broad scope of the appended claims.

What is claimed is:

1. A braking device, for use with a motor vehicle, comprising:
a drum having an inner surface;
a lifting mechanism including a plurality of teeth;
a plurality of carrying members operably coupled to the plurality of teeth and configured to extend outwardly from a center axis of the lifting mechanism, the plurality of carrying members each including a pad for selectively engaging at least a portion of the drum;
a plurality of pins operably coupling the plurality of carrying members to the lifting mechanism; and
at least one cylinder selectively engageable with the lifting mechanism, wherein engagement of the at least one cylinder extends the plurality of carrying members outward from the center axis.

2. The braking device of claim 1, wherein the lifting mechanism includes three teeth.

3. The braking device of claim 2, wherein the braking device includes three carrying members each coupled to one of the three teeth.

4. The braking device of claim 1, further comprising at least one biasing member coupled between the lifting mechanism and the plurality of carrying members.

5. The braking device of claim 4, wherein the biasing member is a spring.

6. The braking device of claim 4, wherein biasing member biases the plurality of carrying members towards the center axis.

7. The braking device of claim 1, wherein about 90% of the inner surface of the drum is contacted by the carrying elements when the carrying elements are fully extended from the center axis.

8. A braking device, for use with a motor vehicle, comprising:
a drum having an inner surface;
a lifting mechanism including a first tooth, a second tooth, and a third tooth;
at least three carrying members each operably coupled to one of the first tooth, the second tooth, and the third tooth, each carrying member configured to extend outwardly from a center axis of the lifting mechanism selectively engaging at least a portion of the drum; and
at least one cylinder selectively engageable with the lifting mechanism, wherein engagement of the at least one cylinder extends the three carrying members outward from the center axis.

9. The braking device of claim 8, wherein the at least one cylinder is operably coupled to the first tooth.

10. The braking device of claim 8, further comprising at least one biasing member coupled between the lifting mechanism and the at least three carrying members.

11. The braking device of claim 10, wherein the biasing member is a spring.

12. The braking device of claim 10 wherein biasing member biases the plurality of carrying members towards the center axis.

13. The braking device of claim 8, wherein about 90% of the inner surface of the drum is contacted by the carrying elements when the carrying elements are fully extended from the center axis.

14. A braking device to apply a braking force, for use with a motor vehicle, comprising:
a lifting mechanism including at least one tooth;
at least one carrying member operably coupled to the at least one tooth and configured to extend outwardly from a center axis of the lifting mechanism to apply the braking force; and
an actuator selectively engageable with the lifting mechanism, wherein engagement of the actuator extends the at least one carrying member outward from the center axis.

15. The braking device of claim 14, further including a drum having an inner surface.

16. The braking device of claim 15, wherein the carrying member includes a pad for selectively engaging at least a portion of the inner surface.

17. The braking device of claim 14, further including a pin operably coupling the carrying member to the lifting member.

18. The braking device of claim 14, wherein the lifting mechanism includes three teeth.

19. The braking device of claim 14, further comprising at least one biasing member coupled between the lifting mechanism and the at least one carrying member.

20. The braking device of claim 19, wherein the biasing member biases the at least one carrying member towards the center axis.
